(19) United States
(12) Patent Application Publication
(10) Pub. No.: US 2013/0177991 A1
(43) Pub. Date: Jul. 11, 2013

(54) AGGREGATION INDUCED EMISSION LUMINOGEN-BASED URINARY PROTEIN DETECTION DEVICE FOR MONITORING HUMAN HEALTH

(71) Applicant: NANO AND ADVANCED MATERIALS INSTITUTE LIMITED, Hong Kong (HK)

(72) Inventors: Benzhong TANG, Hong Kong (HK); Wing Yip LAM, Hong Kong (HK); Tsz Kin KWOK, Hong Kong (HK)

(73) Assignee: NANO AND ADVANCED MATERIALS INSTITUTE LIMITED, Hong Kong (HK)

(21) Appl. No.: 13/727,558

(22) Filed: Dec. 26, 2012

Related U.S. Application Data
(60) Provisional application No. 61/631,661, filed on Jan. 9, 2012.

(51) Int. Cl. G01N 21/64

(52) U.S. Cl. CPC G01N 21/6486
USPC 436/88; 422/69

(57) ABSTRACT

The presently disclosed invention relates to a portable device for detecting one or more urinary proteins based on aggregation-induced emission (AIE) luminogen and quantifying the total urinary proteins in a urine sample in order for monitoring human health, in particular, to a device that utilizes a water-soluble AIE luminogen to detect one or more urinary protein aggregation in order to determine the content of both the target protein and the total urinary proteins in a subject. The device is useful at home or at clinical level for monitoring human health on regular basis.

### CROSS-REFERENCE TO RELATED APPLICATIONS

Pursuant to 35 U.S.C. §119(e), this is a non-provisional patent application which claims benefit from U.S. provisional application Ser. No. 61/631,661 filed Jan. 9, 2012, and the disclosure of which is incorporated herein by reference.

### FIELD OF THE INVENTION

The presently disclosed invention relates to a portable device for detecting urinary proteins based on aggregation-induced emission (AIE) luminogens and quantifying the total urinary proteins in a urine sample in order for monitoring human health, in particular, to a device that utilizes water-soluble AIE luminogens to detect one or more urinary protein(s) in order to determine the content of both the target protein and the total urinary proteins in a subject. The device is useful at home or at clinical level for monitoring human health on regular basis.

### TECHNICAL BACKGROUND

Many human diseases are not diagnosed easily unless in a very late stage because their physiological symptoms are indistinctly. Slight change in the body fluid compositions may indicate that something goes wrong inside the body. Therefore, urine is often used as biomarkers for diagnostics and clinical studies because it is an easily and noninvasively accessible body fluid.

Urine comprises a complex mixture of proteins and peptides, and can reflect the serum composition and kidney function. Appearance of an excess amount of protein in urine is an alert of chronic kidney diseases, such as diabetes, high blood pressure and problems associated with kidney inflammation. Nowadays, colorimetric methods such as Brandford and Lowry assays have been developed for protein quantification in solution. However, these methods generally lack sensitivity and accuracy, in addition to their tedious procedure. Most of the reviewed methodologies utilize urine-testing dipsticks impregnated with pH sensitive dyes for daily monitoring. The detection threshold of the dipsticks can be reached 100-200 mg/L for human serum albumin (HSA), the main protein in urine, while the protein concentration in normal urine of a healthy person is less than 30 mg/L. The dipsticks are obviously not sensitive enough to assay the renal diseases. It is thus of clinical value to develop effective methods for urinary protein detection and quantification at low protein concentration.

Protein biosensors based on fluorescent organic materials have attracted much attention due to their functionality, sensitivity, selectivity, and rapidity. A thorny problem often encountered by conventional luminogens is aggregation-caused quenching (ACQ). When they are dispersed in aqueous media or bound to protein in buffer solution, the molecules are inclined to aggregate, which quenches their fluorescence and thus greatly limits their effective ranges as bioprobes. We have recently discovered an extraordinary phenomenon of aggregation-induced emission (AIE) that is exactly opposite to the ACQ effect (U.S. Pat. Nos. 7,939,613, 8,129,111 & 8,263,018; US Patent Application Pub. No. 2012/0172296 A1, and the disclosure of which is incorporated herein by reference). Instead of quenching, aggregation has enhanced the light emission of some propeller-like molecules, turning them form weak fluorophores into strong emitters. Tetraphenylethene (TPE) is one of such AIE luminogens and enjoys the advantages of high fluorescence quantum yield, ease synthesis and ready functionalization. Decorating TPE with sulfonated functional groups yields water-soluble derivatives, which can be utilized as turn-on fluorescent probes for HSA. The fluorescent intensity linearly increases at HSA concentration range of 0-100 mg/L in artificial urine and the detection limit can be squeezed to as low as 1 mg/L. Besides superior sensitivity, the fluorophore shows an excellent selectivity to HSA among different proteins and DNAs. These exciting results encourage us to further explore its clinical utility. In the present invention, a low-cost, portable, and technically simple multiplexed urinary protein device with high sensitivity based on the AIE fluorescence technology is disclosed. The device can be widely used at home and clinics for daily monitoring of the health condition.

### SUMMARY OF THE INVENTION

The first aspect of the presently disclosed invention relates to a device for detecting a target protein from a urine sample using the AIE luminogens is provided. The device of the present invention mainly includes a case, a light source, a sample container for housing urine sample, a cell holder, a photo-detector, a signal amplifier, output components, and associated integrated circuit. The light source, cell holder, photo-detector, signal amplifier and integrated circuit are enclosed in the case which is configured to avoid background signal from external light during the detection of fluorescence signal from the complex of AIE luminogen and the target proteins. The light source is as light as possible while the dimension of all the components in the device is comparatively small to allow the device be carried easily. The working principle of the device is to use the fluorescence emission ability of the AIE luminogen induced by protein-fluorophore complex in the urine sample under the excitation of the light source with a narrow bandwidth and compare the signal emitted from the AIE luminogen-target protein complex with a pre-determined reference on an artificial urine sample to determine the content of a target protein in the urine sample in order to determine the total urinary protein. The device can provide both qualitative and quantitative data output corresponding to the content of the target protein. The working range for the urinary protein is 0-300 mg/L and the detection limit can be as low as 5 mg/L. However, the working range can be adjusted by turning the concentration of the AIE luminogen to make the linear range fit the tested molecules.

The second aspect of the presently disclosed invention relates to a method of using said device based on the principle of AIE luminogen to detect urinary protein from a urine sample and determine the total urinary proteins. The method includes preparing an AIE compound-containing solution, predisposing the solution into the sample container of said device which is stabilized by the cell holder, injecting the urine sample into the sample container, exposing the container under a light generated by the light source, detecting the fluorescence signal emitted from the AIE luminogen-target protein complex, converting the fluorescence signal into electrical voltage, measuring voltage and comparing the measured voltage with a reference pre-determined on an artificial urine sample against different concentrations of the target protein in order to quantify the content of the target protein in the urine sample, determining the total urinary protein based on the content of the target protein. The electrical signal converted from the fluorescence signal can also be used to turn on other output components if the signal reaches the threshold voltage such that a qualitative output signal can be generated, e.g. a light signal or a sound signal. Both qualitative and qualitative output of the device is almost instantaneous when the detection of fluorescence emission is initiated.

### BRIEF DESCRIPTION OF THE DRAWINGS

FIG. 1 is the molecular structures of different water soluble AIE luminogens used in the present invention.

FIG. 2: (A) Fluorescent (FL) spectra of compound 1, SATPE in phosphate buffered saline (PBS) buffer containing different concentrations of HSA; (B) Change in the FL intensity at 475 nm with HSA concentration; Iₒ=FL intensity in the absence of HSA. Inset: linear region of the binding isotherm of SATPE to HSA. [SATPE]=5 μM; λₑₓ=350 nm.

FIG. 3: (A) Binding isotherm of HSA to SATPE in artificial urine and PBS buffer; (B) Dependence of the FL intensity of SATPE at 475 nm on different proteins in artificial urine and PBS buffer. [SATPE]=5 μM; [protein]=100 μg/mL; λₑₓ=350 nm.

FIG. 4 is a flow chart of how the urinary protein detection device functions.

FIG. 5 is a block diagram of the integrated circuit of the urinary protein detection device.

FIG. 6 is an emission spectrum of a UV LED light source used in the present invention

FIG. 7 is an aerial view of an embodiment of the urinary protein detection device.

FIG. 8: (A) Dependence of voltage on different concentrations of HSA in artificial urine and SATPE (1×10⁻⁴ M) mixture of the urinary protein device; (B) Normalized voltage against different HSA concentrations in artificial urine.

### DEFINITION

The following definitions are provided for the purpose of understanding the present subject matter and for constructing the appended patent claims.

It is noted that, as used in this specification and the appended claims, the singular forms “a,” “an” and “the” include plural references unless the context clearly dictates otherwise

“Aggregation-induced emission” or in short “AIE” means the fluorescence/phosphorescence is turned on upon aggregation formation or in the solid state. When molecularly dissolved, the material with this property is nonemissive. However, the emission is turned on when the intramolecular rotation is restricted.

“Aggregation caused quenching” or in short “ACQ” means the fluorescence/phosphorescence is quenched upon aggregation formation or in the solid state. The luminogens are emissive when they are molecularly dissolved in solution.

“Emission intensity” means the magnitude of fluorescence/phosphorescence normally obtained from fluorescence spectrometer, fluorescence microscopy measurement.

Unless otherwise defined, all technical and scientific terms used herein have the same meaning as commonly understood to one of ordinary skill in the art to which the presently described subject matter pertains.

Unless otherwise stated, all the chemicals used in this study are purchased from Sigma-Aldrich. THF is distilled from sodium benzophenone ketyl under dry nitrogen immediately prior to use. Water is purified by a Millipore filtration system. Artificial urine is prepared and sterilized in autoclave immediately prior to use.

¹H and ¹³C NMR spectra are measured on a Bruker AV 300 spectrometer in CDCl₃ using tetramethylsilane (TMS, δ=0) as internal reference. High resolution mass spectra (HRMS) are recorded on a GCT premier CAB048 mass spectrometer operating in MALDI-TOF mode. Emission spectra are recorded on a Perkin-Elmer LS 55 spectrofluorometer.

The terms “luminogen” and “fluorophore” are used interchangeably herein to refer to the fluorescent dye of the AIE compounds which are capable of emitting fluorescence signal at about 470-475 nm under the excitation of a UV light with a peak at about 350-355 nm.

### DETAILED DESCRIPTION OF THE INVENTION

The water soluble AIE luminogen of the present invention has a backbone of any one of the following formula:

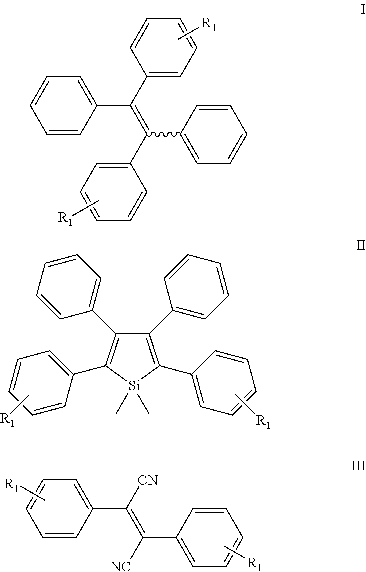

wherein R₁ is independently substituted by a compound selected from the group consisting of (X)ₓSO₃⁻Na⁺ and wherein X is selected from alkyl, unsaturated alkyl, heteroalkyl, cyclyalkyl, heterocycloalkyl, aryl, or heteroaryl, and wherein n=0 to 20.

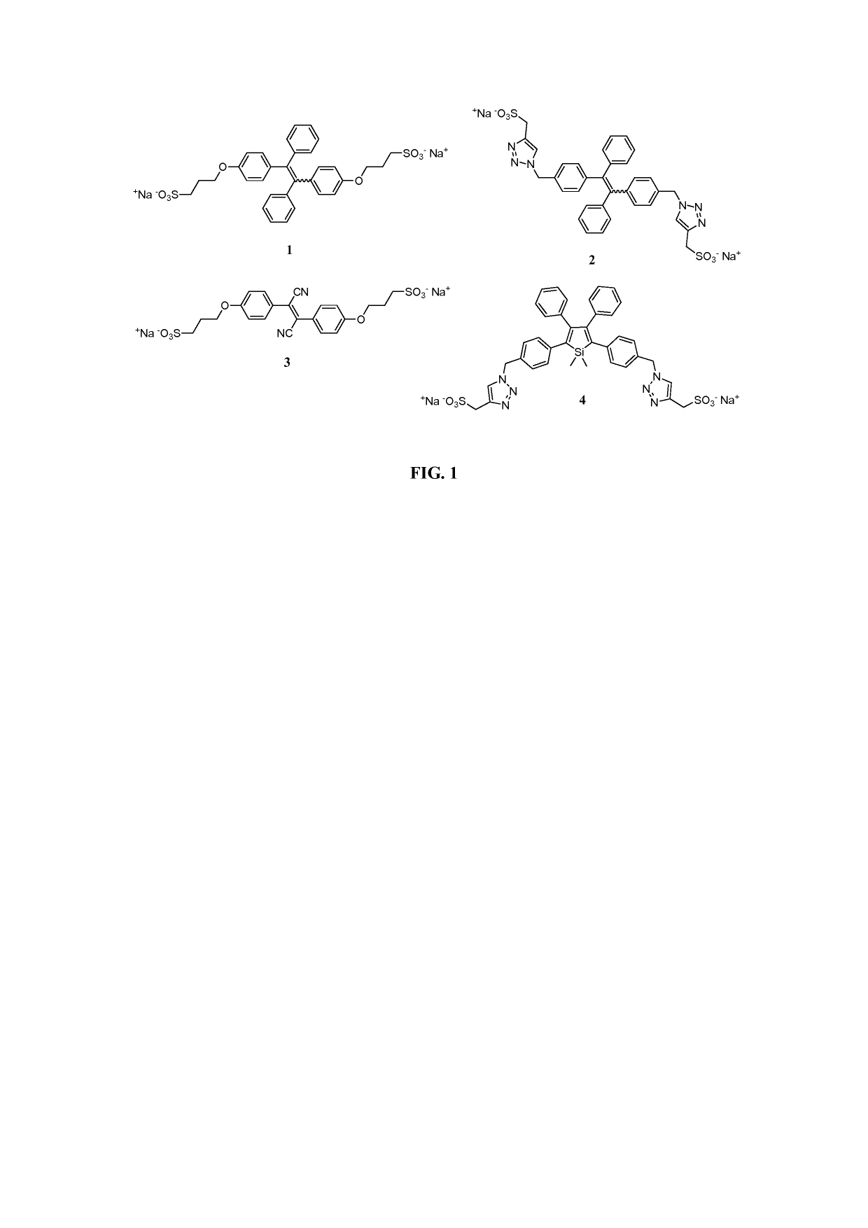

Four embodiments of the water soluble AIE luminogens are shown in FIG. 1, namely compounds 1-4. The compounds 1-4 are prepared according to the synthetic routes as shown in the following Schemes 1-4, respectively:

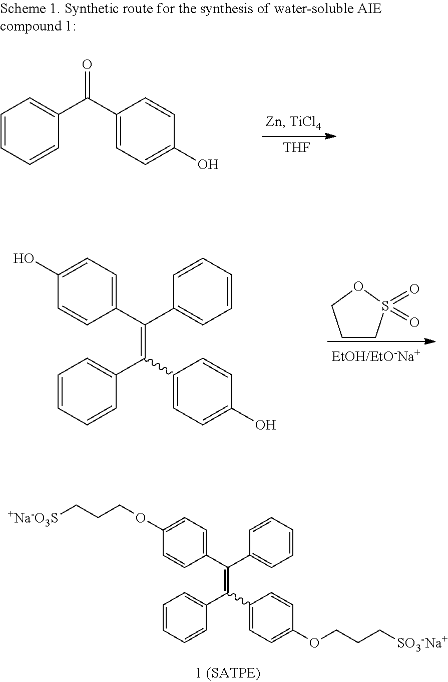

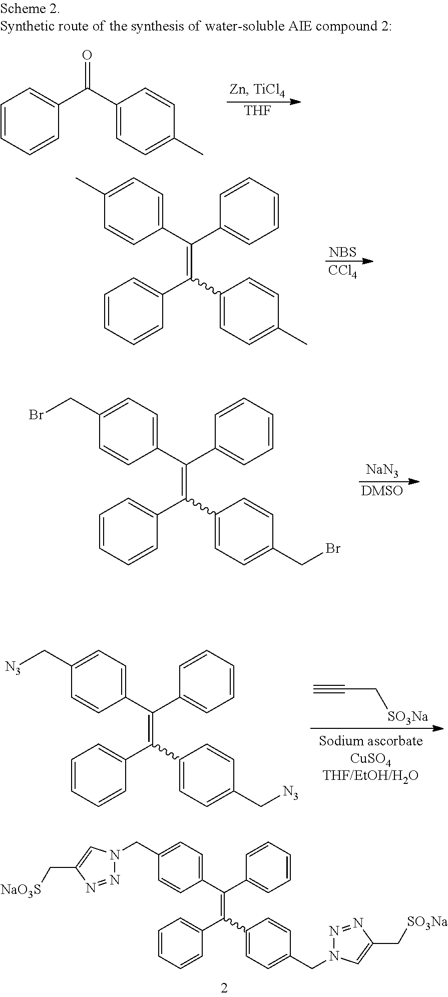

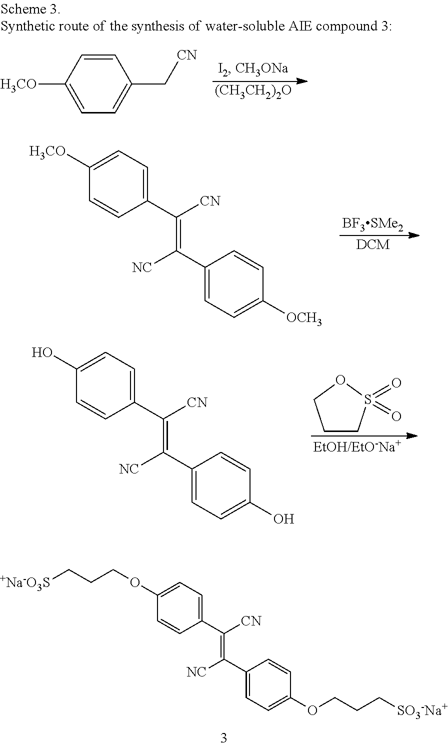

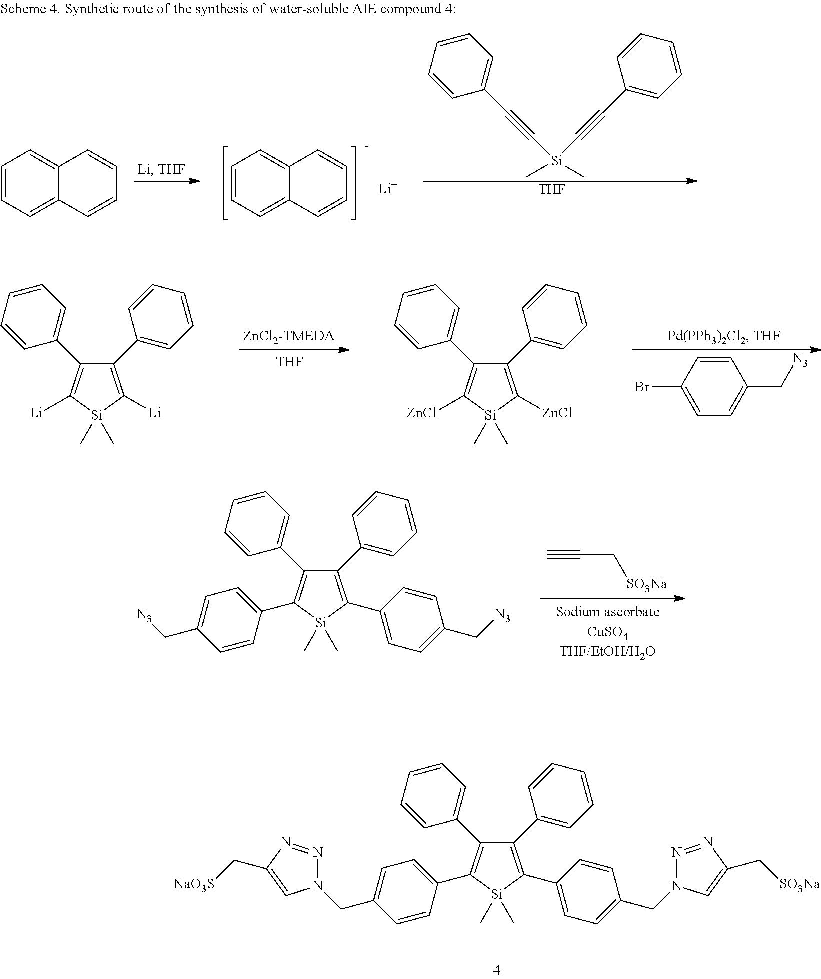

In the first embodiment, Compound 1 is obtained by McMurry coupling of 4-hydroxylbenzophenone followed by nucleophilic substitution with 1,3-propansultone. The crude product of 1 is purified by recrystallization in acetone.

In the second embodiment, Compound 2 is synthesized by “click” reaction of 1,2-bis[4-(azidomethyl)phenyl]-1,2-diphenylethene with sodium prop-2-yne-1-sulfonate in the presence of copper (II) sulfate and sodium ascorbate. The final product is isolated by column chromatography using methanol as eluent.

In the third embodiment, Compound 3 is obtained by deprotection of 2,3-bis(4-methoxyphenyl)fumaronitrile using boron trifluoride methyl sulfide complex followed by nucleophilic substitution with 1,3-propansultone. The product is purified by recrystallization in acetone.

In the fourth embodiment, Compound 4 is prepared by “click” reaction of 2,5-bis(4-(azidomethyl)phenyl)-1,1-dimethyl-3,4-diphenyl-silole with sodium prop-2-yne-1-sulfonate, using copper (II) sulfate and sodium ascorbate as catalysts. The product is purified by column chromatography using methanol as eluent.

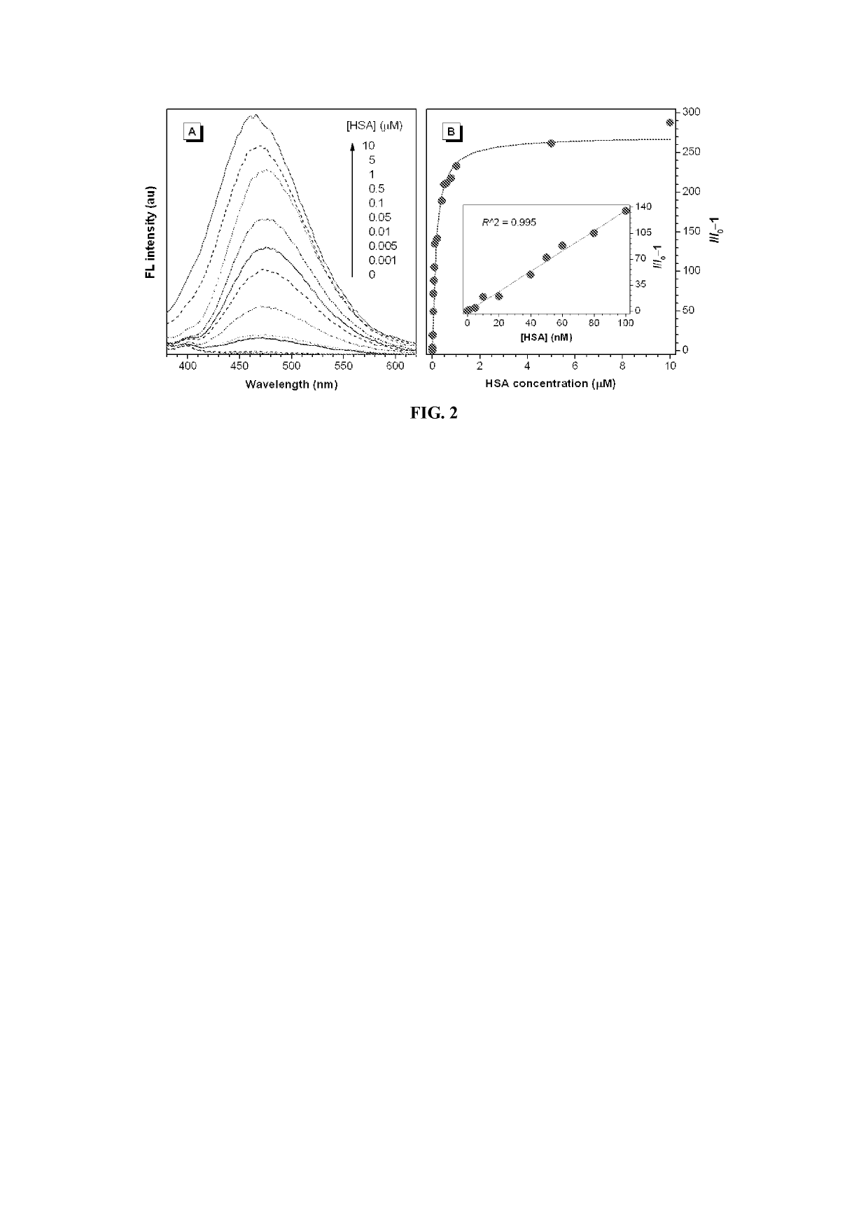

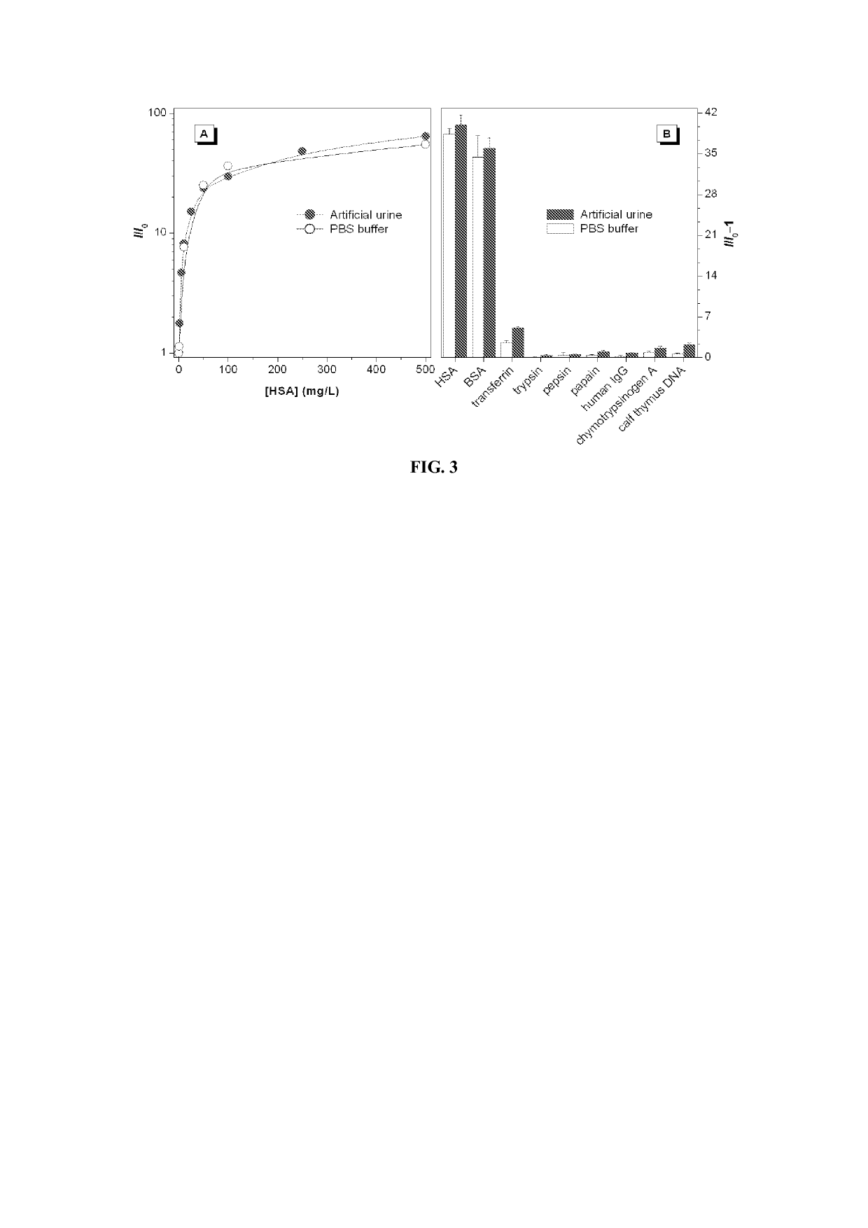

In another embodiment, Compound 1 is AIE-active as it emits faintly in PBS buffer but gives strong light upon aggregate formation. Its solution in PBS buffer is weakly luminescent at 390 nm in the absence of HSA (FIG. 2). Addition of HSA into the solution containing compound 1, however, induces the AIE compound to emit intensely at 475 nm. The higher the HSA content, the stronger is the light emission. The detection limit can be squeezed to as low as 1 nM. In order to examine the feasibility of protein assay in body fluids, artificial urine is utilized as medium in the protein assay. As shown in FIG. 3A, compound 1 displays similar fluorescence property in artificial urine as that in PBS buffer. Besides superior sensitivity, Compound 1 shows an excellent selectivity to HSA and displays no significant response to other human proteins and DNAs (FIG. 3B), thereby affording an accurate and trustworthy protein assay in trace amount. In addition, Compounds 2-4 have similar results to Compound 1 although their emission wavelengths are different.

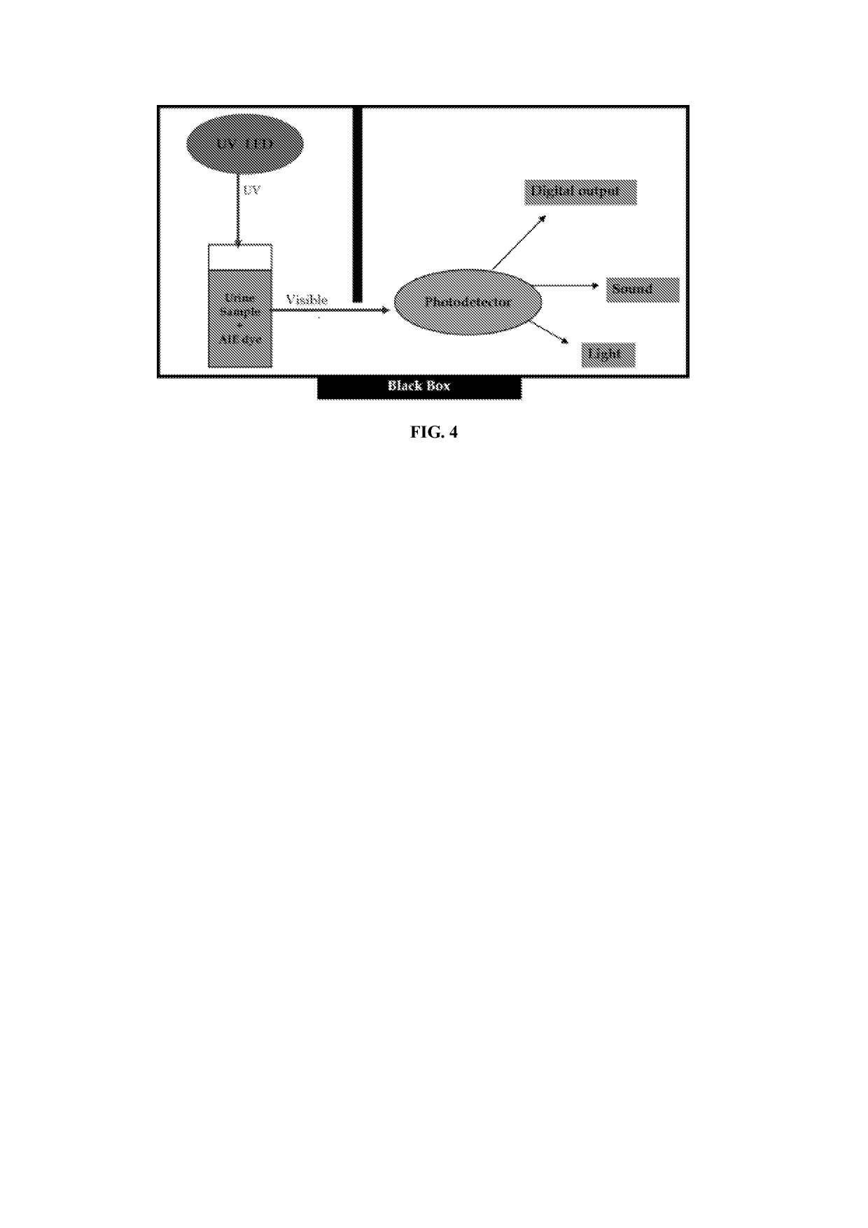

By employing the AIE fluorescence technology in protein assay, a low-cost, portable, and technically simple multiplexed urinary protein device is designed and fabricated. FIG. 4 is a flow chart of how the device can detect the urinary protein. The basic working principle of the protein assay is using water soluble AIE luminogen capable of interacting with the target urinary protein to produce visually or instrumentally detectable fluorescence. In the presence of high protein concentration in the urine sample, the emission of AIE luminogen is induced by the formation of protein-luminogen complex to emit intensely under the UV excitation. The fluorescence signal is not only detectable by the photo-detector but also visible to our human eyes. For quantitative measurement, the emission intensity is converted into electrical voltage which turns on the output components if the voltage exceeds a pre-determined threshold voltage. The resulting measurement can be used to determine the total urinary protein content. The UV exposure, fluorescence detection and measurement are carried out in a light-insulating environment and therefore the respective components should be enclosed in a light-insulating compartment, e.g. a black box.

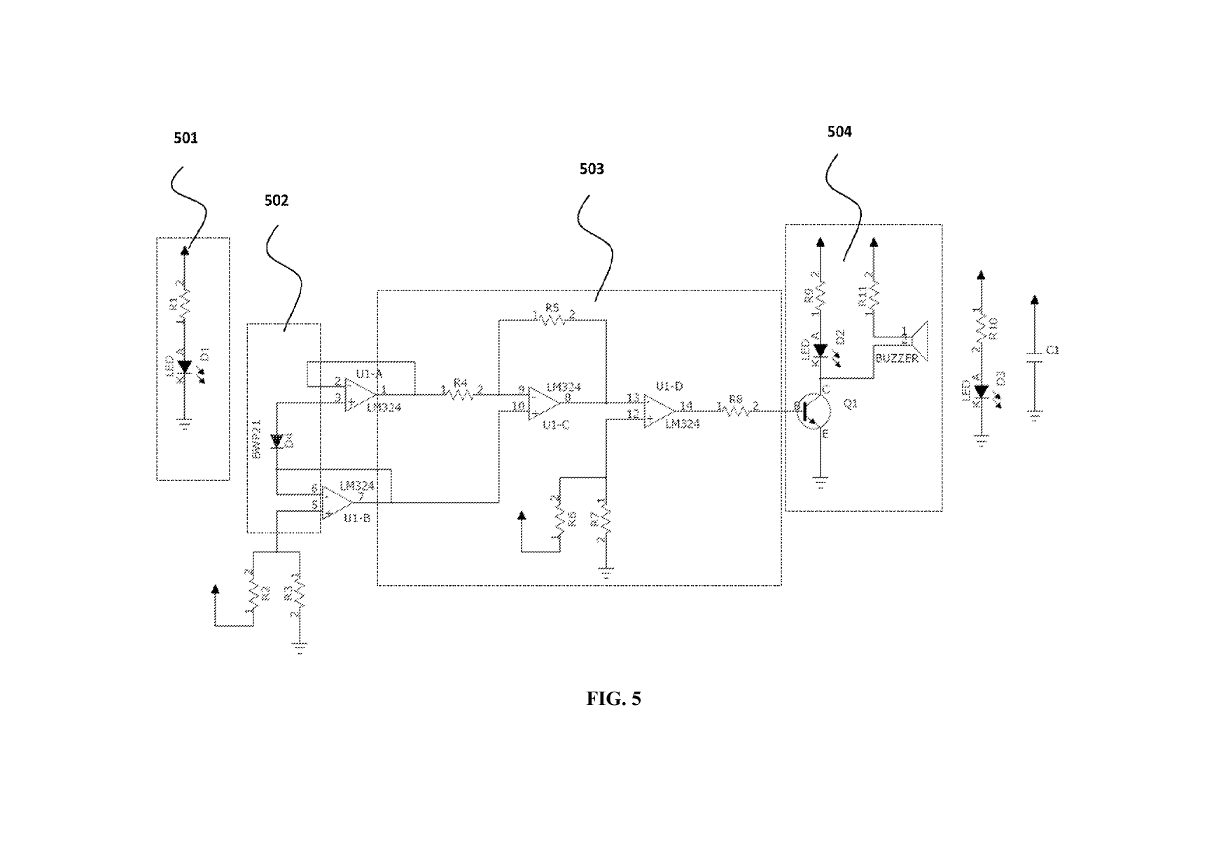

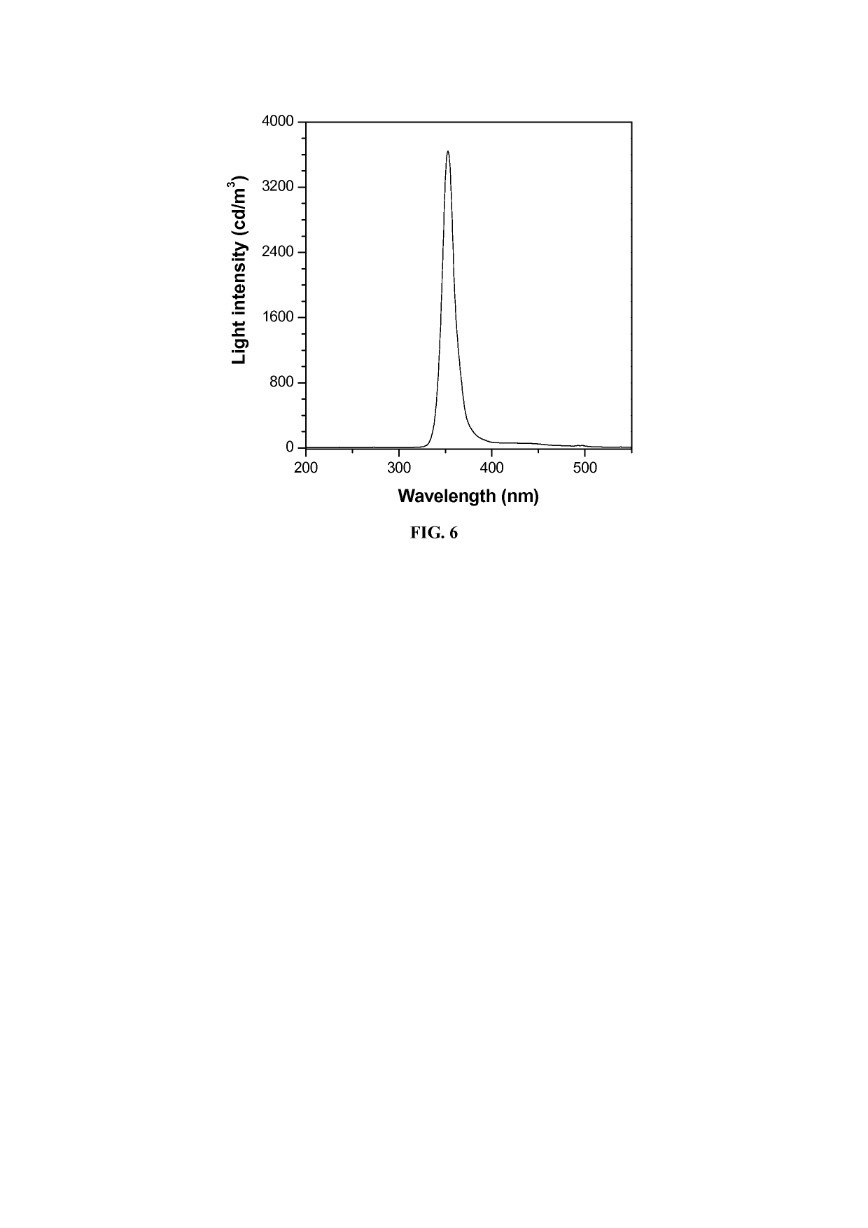

Block diagram of the associated integrated circuit in the urinary protein detection device is shown in FIG. 5. The integrated circuit can be divided into four parts: (1) light source part 501; (2) sample and detection part 502; (3) signal processing part 503; and (4) output part 504. The light source part 501 controls the on and off of a light source, e.g. a UV LED, which is used to excite the AIE luminogen-target protein complex in the sample container. The emission spectrum of the UV LED is peaked at 355 nm with a narrow bandwidth of about 330-390 nm, which matches well with the excitation wavelength of the AIE luminogen but is not detectable by the photo-detector (FIG. 6). Moreover, the small size and light weight of the UV LED are also the major considerations in fabricating a portable device. The sample and detection part 502 mainly controls the photo-detector to detect the fluorescence signal emitted from the AIE luminogen-target protein complex under the UV excitation. The fluorescence received by the photo-detector is converted from photonic energy into electrical energy. About 20 mV is maximally generated from the photo-detector. As the signal is weak and not sensitive to detect, it is necessary to amplify that signal. The signal processing part 503 includes an amplifier which amplifies the electrical signal several times, and a voltage comparator which sets the threshold voltage to control on/off of the output components. The voltage gain is defined as

$$\frac{\text{?}}{\text{?}} -- \frac{\text{?}}{\text{?}}$$

$$\text{?} \text{indicates text missing or illegible when filed}$$

and the amplified electrical signal ranges from 0V to 9V. The voltage comparator is configured to compare two input voltage values v+ and v−, and whereby outputs either 9V or 0V. The corresponding equation is

$$\text{?} = A ( \text{?} - \text{?} ) = \{ \begin{matrix}9 V & \text{?} > {v}_{-} \\ 0 V & \text{?} < {v}_{-} .\end{matrix} \\ \text{?} \text{indicates text missing or illegible when filed}$$

When the visible light emission from the AIE luminogen-target protein complex is strong enough to be detected by the photo-detector, the amplified signal causes the voltage comparator to become 9V, and as such turns-on the output components. When the visible light emission from the AIE luminogen-target protein complex is not strong enough to trigger the voltage comparator, the voltage comparator remains 0V and the associated output components will not be turned on. In any circumstances, a quantitative output by a voltmeter is still available regardless of the control by the voltage comparator. The output part 504 is connected to several output components which can display the presence of the urinary protein in the sample by three different output signals: i) LED that gives light signal; ii) buzzer which provides sound and iii) voltmeter which displays digital number for quantitative measurement. It should be noted that any suitable output components can be incorporated into the device to quantify the target protein in the urine sample.

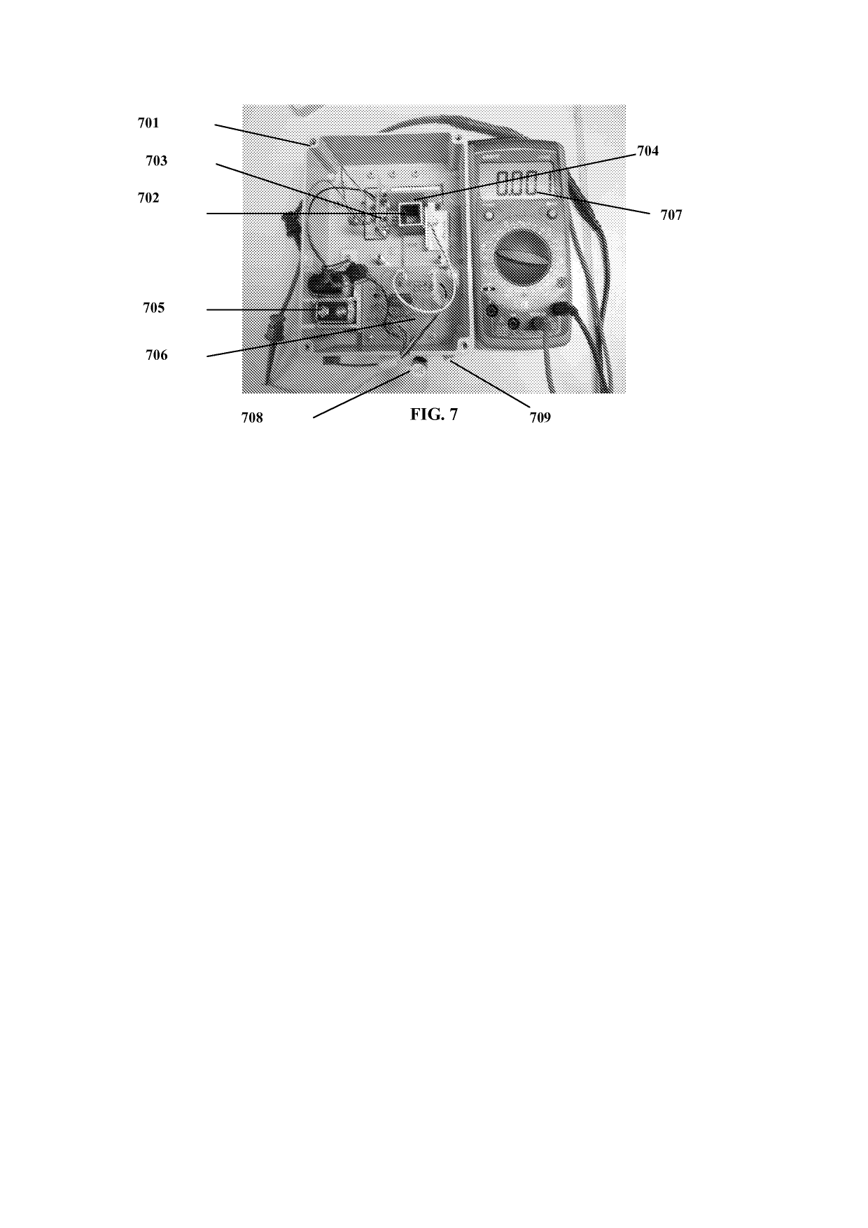

The appearance of the urinary protein detection device prototype is shown on FIG. 7. It can be seen that the size is comparatively smaller than other conventional protein assay systems. In this embodiment, a plastic case 701 is used to house the components of the urinary protein detection device. The case 701 can be made of other materials but the basic requirements are light-insulating and light in weight in order to make the device handy. The sample container is preferably plastic-made and disposable to prevent contamination in tests. Its dimension is 1 cm×1 cm×5 cm and can store 5 mL of solution. The urine sample and predisposed AIE solution are mixed inside the sample container for the analysis. A cell holder 702 is housed inside the plastic case 701. The function of the cell holder 702 is to fix the position of the sample container. The net weight of the device can be less than 1.5 kg. An ideal dimension of the device which is for portable use is about 162 mm×124 mm×80 mm. A UV LED 703 is equipped to emit UV light in a narrow bandwidth of 330 nm to 390 nm for exciting the protein-luminogen complex contained in the sample container during detection. A photo-detector 704 is positioned in the case 701 along the light path of the emission from the protein-luminogen complex under the excitation of UV light by the UV LED 703 such that the photo-detector 704 can receive the maximum intensity of the emission. To achieve the goal of making a handy detection device, besides AC supply mode, power can be supplied by DC, i.e. batteries 705. The batteries 705 can be non-rechargeable or rechargeable. When AC supply is available, the device can be switched to AC supply mode. A signal amplifier 706 is also housed in the case 701 for amplifying the voltage converted from the light signal by the photo-detector 704 into a level that is measurable by an output component or capable of turning on other output components when the amplified voltage exceeds a pre-determined threshold voltage. A voltmeter 707 is equipped for measuring the amplified voltage from the signal amplifier 706 in order to provide a quantitative data. Optionally, other output components such as buzzer 707 and/or a LED 708 can be additionally equipped to provide qualitative output signals such as sound or light when the amplified signal from the signal amplifier 706 exceeds the pre-determined threshold voltage input in the device. When the buzzer 707 and/or the LED 708 is/are turned on according to this working principle, it gives an instantaneous response to the user that the subject who provides the urine sample is unhealthy in terms of the detectable urinary protein content in the urine sample under the test as compared to a reference sample which contains a reference content of urinary protein for setting the pre-determined threshold voltage. In this embodiment, the pre-determined threshold voltage is set by using a reference sample containing 30 mg/L of HSA. However, the threshold voltage is easily adjustable according to the needs of the user in different circumstances. Although the output components in this embodiment are equipped outside the case 701, the components can also be equipped inside the case. One of the advantages of equipping the output components outside the case is that the output components can be easily detachable and replaced by other suitable output components.

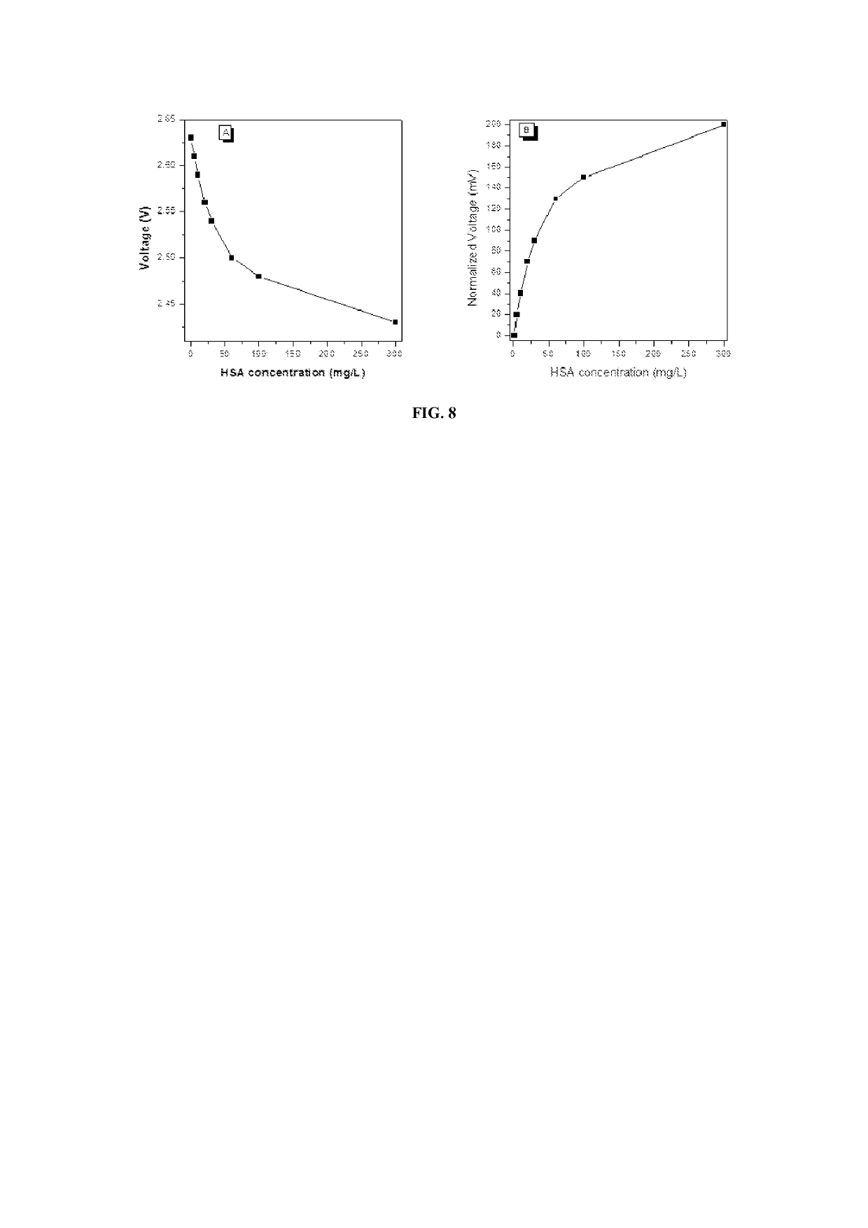

The performance test of the device is done by recording the voltage at different HSA concentrations. The voltage difference between mixtures with 0 mg/L and 300 mg/L protein concentrations is ˜200 mV (FIG. 8). The magnitude of the voltage change at low protein concentration is more obvious, which helps differentiate the patients and healthy persons easily. The threshold voltage for the device of the present invention is adjustable according to the needs but the main objective of setting a threshold voltage for the device is to differentiate healthy subject from diseased or suspected subjects when the total urinary proteins in a urine sample exceed certain concentration that hits the threshold voltage. A qualitative output signal can be generated to give an instantaneous response to the user of the device that the health status of the subject under the test in terms of the detectable urinary protein content.

Being simple operation and small in size, the device can be widely used in home and clinics for daily monitoring the health condition.

### EXAMPLES

### Synthesis of Water Soluble AIE Compound 1

Into a 250 mL two-necked round bottom flask, a suspension of 4-hydroxylbenzophenone and 3 equivalence of Zn dust in 80 mL of dry THF is cooled at −78° C. under N₂. TiCl₄ was then added dropwisely into the solution mixture. After warmed to room temperature, the mixture was refluxed for 12 h. The reaction mixture was cooled to room temperature and then filtered. The filtrates were evaporated and the crude product was purified by recrystallization from THF/methanol to afford a white solid of 1,2-bis(4-hydroxylphenyl)-1,2-diphenylethene).

Into a 100 mL round-bottom flask were added 0.5 g (1.37 mmol) of 1,2-bis(4-hydroxylphenyl)-1,2-diphenylethene and 20 mL of anhydrous ethanol under N₂. The mixture was stirred until all solids were dissolved. A mixture of NaOEt (0.20 g, 3.0 mmol) in 20 mL of ethanol was then added dropwisely, which turned the colorless solution to turn orange-red after stirred for 1 h. Into the solution was then added 0.35 g of 1,3-propanesultone (2.88 mmol) in 20 mL of ethanol. The mixture was vigorously stirred for 12 h, during which a white product was precipitated from the solution. The product was collected by filtration and washed with ethanol and acetone twice to give a white solid.

Synthesis of Water Soluble AIE Compound 2

A suspension of 1,2-bis[4-(azidomethyl)phenyl]-1,2-diphenylethene (1 mmol), sodium prop-2-yne-1-sulfonate (4 mmol), copper(II) sulfate (0.2 mmol) and sodium ascorbate (2 mmol) were dissolved in 6 mL of THF/H₂O/ethanol (1:1:1). The mixture was stirred at room temperature overnight. The insoluble impurity was filtered and the remaining filtrate was freeze dried. The product is purified by column chromatography using methanol as eluent.

Synthesis of Water Soluble AIE Compound 3

Boron trifluoride methyl sulfide complex (50 mmol) was added into a solution of 2,3-bis(4-methoxyphenyl)fumaronitrile (1 mmol) in DCM under N₂. The solution was stirred at ambient temperature overnight. The solution was concentrated under a stream of N₂ and the crude product was extracted by ethyl acetate and diluted HCl solution. The organic layer was concentrated. The crude product was transferred to a two necked round bottom flask and dissolved in anhydrous ethanol filled with N₂. A mixture of NaOEt (3.0 mmol) in ethanol was then added dropwisely, which turned the colorless solution to turn orange-red after stirred for 1 h. Into the solution was then added 1,3-propanesultone (2.88 mmol). The mixture was vigorously stirred for 12 h, during which a white product was precipitated from the solution. The product was collected by filtration and washed with ethanol and acetone twice to give a white solid.

Synthesis of Water Soluble AIE Compound 4

A solution of 2,5-bis(4-(azidomethyl)phenyl)-1,1-dimethyl-3,4-diphenyl-silole (1 mmol), sodium prop-2-yne-1-sulfonate (4 mmol), sodium ascorbate (2 mmol) and catalytic amount of copper(II) sulfate in THF/H₂O/ethanol (1:1:1) was stirred at room temperature overnight. The insoluble impurity was filtered and the remaining filtrate was freeze dried. The product is purified by column chromatography using methanol as eluent.

Preparation of Artificial Urine

Artificial urine was prepared according to the recipe provided by Brooks and Keevil. A mixture of lactic acid (1.1 mM, 0.096 mL), citric acid (2.0 mM, 0.42 g), sodium bicarbonate (2.5 mM, 0.21 g), urea (170 mM, 10.21 g), calcium chloride (2.5 mM, 0.278 g), sodium chloride (90 mM, 5.26 g), magnesium sulphate (2.0 mM, 0.24 g), sodium sulfate (10 mM, 1.42 g), potassium dihydrogen phosphate (7.0 mM, 0.95 g), dipotassium hydrogen phosphate (7.0 mM, 1.22 g) and ammonium chloride (25 mM, 1.34 g) were dissolved in 1000 mL of Millipore water. The pH value of the solution was adjusted to 6.00 through the addition of aliquots of 1.0 M hydrochloric acid. Then the aqueous solution was sterilized in autoclave.

Protein Assay

In a disposable plastic container, 1.5 mL of analyzed sample was mixed with 1.5 mL of predisposed compound 1 solution (1 μM). The container was put into container holder and UV LED was switched on. Fluorescence emitted from the protein-luminogen complex was converted into electrical signal by photo-detector. The magnitude of the voltage generated was transformed to digital number displayed by the voltmeter.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes exemplary embodiments of the invention, these descriptions should not be viewed in a limiting sense. Rather, there are several variations and modifications which may be made without departing from the scope of the present invention as defined in the appended claims.

What we claim:

1. A portable urinary protein detection device for detecting and quantifying total urinary proteins in a urine sample using water soluble aggregation-induced emission luminogen, the device comprising a light-insulating case, a light source, a sample container, a cell holder, a photo-detector, a signal amplifier, a plurality of output components, and associated integrated circuit,
wherein said light source, said cell holder, said photo-detector, said signal amplifier, and associated integrated circuit are enclosed in said case to isolate from external light during said detecting;
said light source is a LED light source capable of generating a light having a narrow bandwidth which matches the excitation wavelength of said water soluble aggregation-induced emission luminogen and is outside the emission spectrum of said aggregation-induced emission luminogen;
said sample container is configured to house said water soluble aggregation-induced emission luminogen and said urine sample for emission to take place under exposure to said light source;
said cell holder is configured to fix the position of said sample container during said detecting;
said photo-detector is configured to detect fluorescence signal emitted from said water soluble aggregation-induced emission luminogen and said urine sample in said sample container under the exposure to said light source and convert the fluorescence signal into electrical signal;
said signal amplifier is configured to amplify the electrical signal from 0-9V;
said voltage comparator is configured to set a threshold voltage for comparison with the amplified electrical signal by said signal amplifier in order to determine whether said output components is/are turned on and/or the magnitude of said amplified electrical signal is measured quantitatively by said output components; and
said output components are configured to reflect the level of urinary proteins in the sample qualitatively and/or quantitatively.

2. The device of claim 1, wherein said water soluble aggregation-induced emission luminogen comprises a backbone of any one of the following formula: 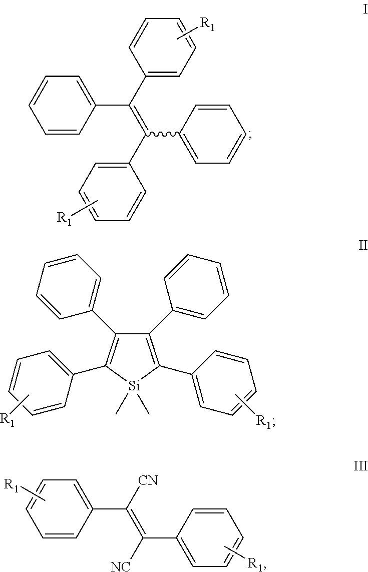
wherein R₁ is independently substituted by a compound selected from the group consisting of (X)ₓSO₃⁻Na⁺ and wherein X is selected from alkyl, unsaturated alkyl, heteroalkyl, cyclyalkyl, heterocycloalkyl, aryl, or heteroaryl, and wherein n=0 to 20.

3. The device of claim 2, wherein said water soluble aggregation-induced emission luminogen is capable of interacting with said target urinary protein in order to produce instrumentally detectable fluorescence emission and visible color.

4. The device of claim 2, wherein said water soluble aggregation-induced emission luminogen comprising any one of the following formula:

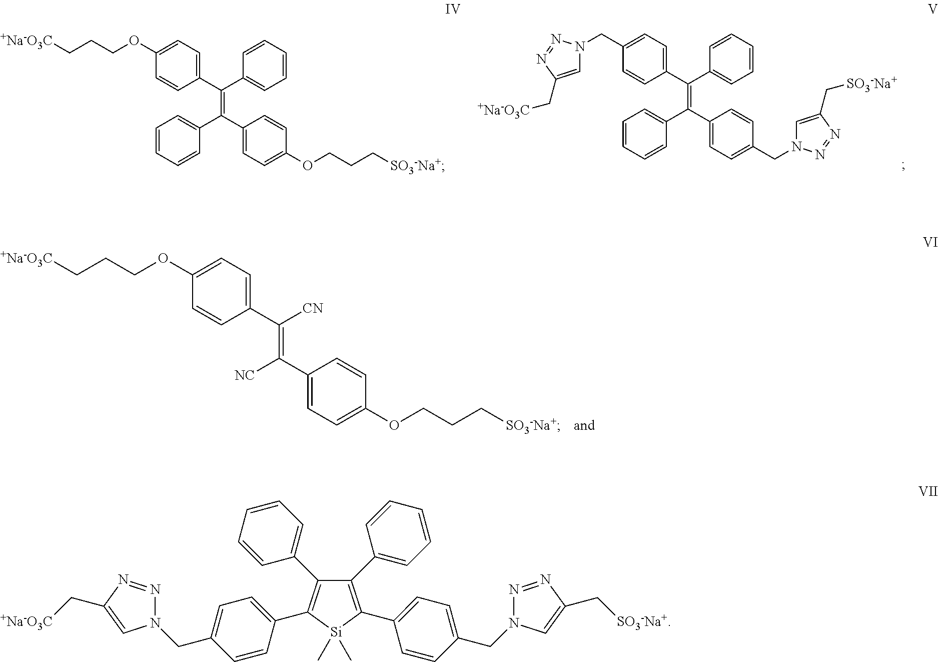

5. The device of claim 4, wherein said water soluble aggregation-induced emission luminogen is specific to human serum albumin.

6. The device of claim 1, wherein said light source is a UV LED light source capable of generating UV light having a bandwidth from 330 nm to 390 nm and a peak light intensity at about 350 nm which matches the excitation wavelength of said water soluble aggregation-induced emission luminogen.

7. The device of claim 3, wherein said water soluble aggregation-induced emission luminogen has the maximum emission intensity at about 475 nm when interacting with said urinary proteins under exposure to said light source.

8. The device of claim 1, wherein said sample container has a dimension of 1 cm×1 cm×5 cm and a maximum volume of about 5 mL.

9. The device of claim 1, wherein said sample container is made of plastic and disposable.

10. The device of claim 1, wherein said associated integrated circuit comprises a light source part for controlling on and off of said light source, sample and detection part for receiving fluorescence signal from said photo-detector and converting said fluorescence signal into electrical signal, signal processing part for controlling said signal amplifier, and output part for receiving the voltage and turning on said output components.

11. The device of claim 1, wherein said output components comprises one or more of light emitting device, sound generating device, and voltmeter.

12. The device of claim 1 has a dimension of about 162 mm×124 mm×80 mm.

13. The device of claim 1 has a net weight of less than 1.5 kg.

14. The device of claim 1, wherein the working range of said water soluble aggregation-induced emission luminogen for said urinary proteins is 0-300 mg/L.

15. The device of claim 1, wherein the detection limit of said water soluble aggregation-induced emission luminogen for said urinary proteins is about 5 mg/L.

16. The device of claim 4, wherein said water soluble aggregation-induced emission luminogen is capable of emitting maximum fluorescence signal at about 475 nm when interacting with human serum albumin in the urine sample and has a detection limit of about 1 nM.

17. A method for determining total urinary proteins in a urine sample based on a water soluble aggregation-induced emission luminogens comprising:
preparing a solution containing said water soluble aggregation-induced emission luminogen;
predisposing said solution into a sample container which is mounted by a cell holder;
injecting the urine sample into the sample container predisposed with said solution;
exposing said sample container to a UV light at about 355 nm generated by a light source;
detecting the fluorescence signal emitted from the mixture of said solution and said urine sample at about 475 nm;
converting the fluorescence signal into electrical signal and amplifying said electrical signal into detectable voltage;
measuring said voltage and comparing said voltage with a pre-determined voltage recorded from a reference sample with different concentrations of target protein in order to determine the content of the target protein in said urine sample; and
determining the total urinary protein based on the content of the target protein in said urine sample.

18. The method of claim 17, wherein said voltage further turns on other output devices to generate an output signal when said voltage exceeds a threshold voltage.

19. The method of claim 18, wherein said output signal is selected from light emission or sound or any signals that are sensible for human beings.

20. The method of claim 17, wherein from said predisposing to said detecting are carried out in a light-insulating environment or compartment.

21. The method of claim 17, wherein said water soluble aggregation-induced emission luminogen comprising any one of the following formula: [chemical structure]
